(19) United States
(12) Patent Application Publication
(10) Pub. No.: US 2026/0097391 A1
(43) Pub. Date: Apr. 9, 2026

(54) CATALYSTS FOR OXYGEN REDUCTION REACTIONS AND METHODS OF SYNTHESIS THEREOF

(71) Applicant: Purdue Research Foundation, West Lafayette, IN (US)

(72) Inventors: Jian Xie, Zionsville, IN (US); Qi Zhang, Indianapolis, IN (US); Guangqi Zhu, Indianapolis, IN (US)

(73) Assignee: Purdue Research Foundation, West Lafayette, IN (US)

(21) Appl. No.: 19/323,433

(22) Filed: Sep. 9, 2025

Related U.S. Application Data
(60) Provisional application No. 63/703,547, filed on Oct. 4, 2024.

(51) Int. Cl. B01J 23/63; B01J 21/18; B01J 23/89; B01J 35/45; B01J 37/08; B01J 37/18; H01M 4/90

(52) U.S. Cl. CPC B01J 23/63; B01J 21/18; B01J 23/8913; B01J 35/45; B01J 37/08; B01J 37/18; H01M 4/9058; H01M 4/9083

(57) ABSTRACT

A method for synthesizing ternary metal alloy catalysts through solid-state synthesis and thermal diffusion is provided. The method includes forming binary metal alloys through solid-state synthesis, incorporating third metals through thermal diffusion, and annealing under reducing atmospheres to form ternary alloy nanoparticles. The resulting nanoparticles have core-shell structures with selective metal distribution and multiple intermetallic phases. Platinum-rare earth-transition metal systems are formed with enhanced catalytic activity for electrochemical applications. The synthesis approach enables controlled formation of ternary structures previously difficult to achieve through conventional methods, supporting applications in fuel cells and other electrochemical devices requiring improved catalyst performance and durability.

### CROSS-REFERENCE TO RELATED APPLICATIONS

This application is related to and claims priority benefit of U.S. Provisional Application No. 63/703,547 entitled “CATALYSTS FOR OXYGEN REDUCTION REACTIONS AND METHODS OF SYNTHESIS THEREOF” filed Oct. 4, 2024, the contents of which are hereby incorporated by reference in their entirety into the present disclosure.

### FIELD OF THE DISCLOSURE

Embodiments of the present disclosure relate generally to methods for synthesizing ternary metal alloy catalysts and, more particularly, to solid-state synthesis methods for enabling ternary platinum-based alloy catalysts with core-shell structures for electrochemical applications.

### BACKGROUND OF THE DISCLOSURE

In electrochemical device applications, efficient catalysts are needed for optimizing performance in fuel cells, electrolyzers, and energy storage systems. Traditional platinum-based catalysts face challenges related to high cost, limited durability, and suboptimal activity for oxygen reduction and other electrochemical reactions, particularly in applications requiring extended operational periods.

Existing catalyst synthesis approaches often require trade-offs between activity and stability. Binary platinum alloys have been developed to improve catalytic performance compared to pure platinum, but these systems typically exhibit limitations in achieving optimal electronic properties and active site configurations. Conventional binary systems may not provide sufficient active site diversity or electronic optimization for demanding electrochemical applications.

Conventional wet-chemical synthesis methods face significant limitations when incorporating rare earth elements due to their low reduction potentials and high sensitivity to water and oxygen. These challenges result in difficulties achieving controlled composition and structure in multi-component alloy systems. Traditional synthesis approaches often produce heterogeneous compositions or uncontrolled phase distributions that limit catalytic performance.

Existing synthesis methods for multi-component platinum alloys typically rely on simultaneous incorporation of all metallic components, which can result in compositional inhomogeneities and suboptimal structural configurations. Single-step synthesis approaches may not provide adequate control over metal distribution or phase formation, particularly when combining elements with significantly different chemical properties.

Consequently, there exists a need for methods that enable controlled synthesis of multi-component platinum-based alloy catalysts with improved structural control and performance characteristics. Such methods would benefit the development of advanced electrochemical devices requiring enhanced catalyst activity, stability, and cost-effectiveness.

### BRIEF SUMMARY OF THE DISCLOSURE

Embodiments of the present disclosure provide methods for synthesizing ternary metal alloy catalysts through solid-state synthesis and thermal diffusion processes. The disclosed methods address the challenges associated with incorporating rare earth and transition metals into platinum-based systems by implementing a systematic two-step approach that creates controlled core-shell structures with multiple intermetallic phases.

The methods disclosed herein include forming binary metal alloys through solid-state synthesis, incorporating third metals through thermal diffusion processes, and annealing under reducing atmospheres to achieve ternary alloy nanoparticles with enhanced structural and electronic properties. The approach enables formation of core-shell architectures where different metals are selectively distributed in inner and outer regions, creating synergistic effects that improve catalytic performance.

In various embodiments, the ternary alloy systems comprise platinum, rare earth metals, and transition metals in configurations that provide multiple intermetallic phases. The methods accommodate various precursor materials, synthesis temperatures, and atmospheric conditions while maintaining controlled composition and structure formation. The resulting catalysts exhibit enhanced activity for electrochemical reactions compared to binary counterparts.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1A illustrates X-ray diffraction patterns comparing binary Pt5Ce/C and ternary Pt5CeCo/C alloys, demonstrating structural evolution upon cobalt incorporation, in accordance with some embodiments discussed herein;

FIG. 1B illustrates a scanning transmission electron microscopy image of binary Pt5Ce/C nanoparticles showing hexagonal particle morphology, in accordance with some embodiments discussed herein;

FIG. 1C illustrates a scanning transmission electron microscopy image of ternary Pt5Ce—Co/C nanoparticles revealing core-shell structure with distinct metal distribution, in accordance with some embodiments discussed herein;

FIG. 2A shows mass activity comparison for ternary Pt5CeCo/C, binary Pt5Ce/C, and binary Pt3Co/C catalysts, demonstrating performance of the ternary system, in accordance with some embodiments discussed herein;

FIG. 2B illustrates oxygen reduction reaction polarization curves comparing the catalytic performance of ternary and binary alloy systems, in accordance with some embodiments discussed herein;

FIG. 2C provides fuel cell polarization and power density curves demonstrating practical device performance using ternary Pt5CeCo/C catalysts, in accordance with some embodiments discussed herein; and

FIG. 3 provides a flowchart showing the synthesis method steps for forming ternary platinum-based alloy catalysts through sequential solid-state synthesis and thermal diffusion processes, in accordance with some embodiments discussed herein.

### DETAILED DESCRIPTION

Exemplary embodiments of the present disclosure will be described more fully hereinafter with reference to the accompanying drawings, in which some, but not all embodiments of the present disclosure are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

The methods according to the present disclosure enable controlled synthesis of ternary metal alloy catalysts through sequential solid-state synthesis and thermal diffusion processes. In various embodiments, the disclosed methods accommodate ternary alloy systems comprising platinum, rare earth metals, and transition metals while achieving core-shell architectures with multiple intermetallic phases and enhanced electrochemical properties. The synthesis approaches disclosed herein address the practical challenges associated with rare earth metal incorporation into platinum-based catalyst systems by implementing solid-state methodologies that overcome the limitations of traditional wet-chemical approaches.

Traditional wet-chemical synthesis methods face significant limitations when processing rare earth elements due to their low reduction potentials and high sensitivity to oxygen and moisture environments. The solid-state synthesis methodology enables controlled formation of binary platinum-rare earth alloys as stable precursors for subsequent ternary structure development through thermal diffusion processes. The thermal diffusion incorporation technique creates ternary alloy nanoparticles with distinct core-shell architectures where different metallic components achieve selective spatial distribution throughout the nanoparticle structure.

The core regions concentrate the rare earth metal components from the initial binary alloy formation, while outer regions accommodate the subsequently incorporated transition metal through controlled high-temperature diffusion processes. This selective distribution creates multiple intermetallic phases within individual nanoparticles, enabling synergistic electronic effects between rare earth and transition metal components that enhance catalytic performance beyond the capabilities achieved by binary alloy systems alone. The resulting ternary alloy catalysts demonstrate superior mass activity and electrochemical surface area compared to conventional binary platinum alloys through optimized electronic properties and enhanced active site configurations.

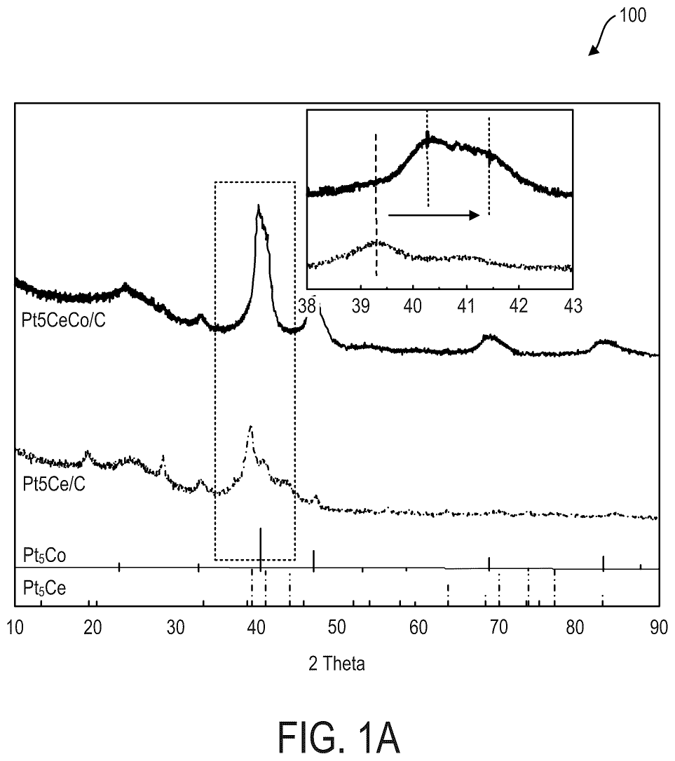

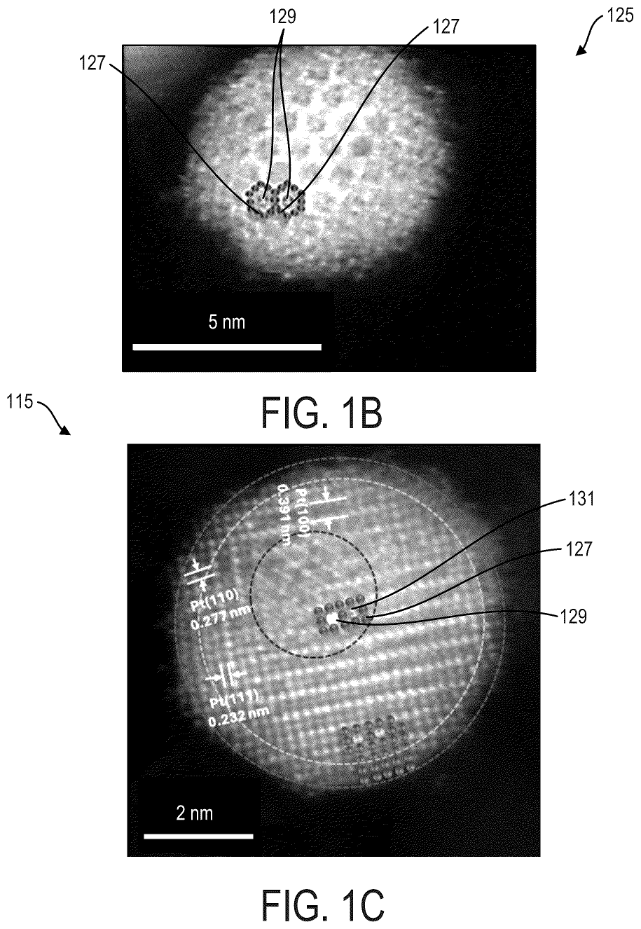

FIG. 1A illustrates chart 100 showing X-ray diffraction patterns comparing binary platinum-rare earth alloys and ternary platinum-rare earth-transition metal systems, demonstrating crystalline structural evolution upon transition metal incorporation. Chart 100 shows X-ray diffraction patterns comparing binary and ternary systems, revealing crystalline phase evolution and peak position changes upon third metal incorporation. The overlaid diffraction patterns in chart 100 demonstrate structural relationships between the starting binary alloy and the final ternary product through systematic peak shifts, new phase emergence, and lattice parameter modifications. The comparative XRD analysis enables identification of successful transition metal incorporation, quantifies lattice parameter changes, and confirms formation of multiple coexisting intermetallic phases within the ternary system. This structural validation provides fundamental evidence that the thermal diffusion process successfully creates ternary alloys with coexisting phases, which is essential for the enhanced catalytic performance and synergistic electronic effects observed in electrochemical testing.

Chart 100 comprises diffraction intensity data plotted against two-theta angles spanning approximately 10 to 90 degrees, encompassing the characteristic reflections that define the crystalline structures of both binary and ternary alloy systems. The overlaid patterns in chart 100 reveal systematic changes in peak positions, intensities, and peak shapes that quantify the structural modifications occurring during ternary alloy synthesis. Chart 100 demonstrates clear peak shifts toward higher diffraction angles in the ternary system, indicating lattice parameter reduction consistent with successful incorporation of transition metal atoms into the binary alloy crystal structure. The peak shift magnitude and direction provide quantitative evidence of compositional changes and lattice strain effects achieved through thermal diffusion processes.

In specific embodiments, chart 100 demonstrates the structural evolution from binary Pt5Ce alloys to ternary Pt5Ce—Co systems through controlled cobalt incorporation during thermal diffusion processing. The binary Pt5Ce pattern in chart 100 exhibits characteristic reflections corresponding to hexagonal close-packed intermetallic structures with ordered atomic arrangements, while the ternary Pt5Ce—Co pattern shows additional structural features indicating the formation of cubic phases alongside the preserved hexagonal structures. This dual-phase formation creates the multiple intermetallic phases essential for enhanced catalytic performance. In some embodiments, chart 100 demonstrates structural evolution from binary platinum-cerium systems to ternary platinum-cerium-cobalt configurations. In some embodiments, chart 100 shows evolution from binary platinum-lanthanum alloys to ternary platinum-lanthanum-nickel systems. In some embodiments, the binary alloys comprise platinum-yttrium configurations that evolve to ternary platinum-yttrium-iron systems upon transition metal incorporation. In some embodiments, chart 100 demonstrates platinum-scandium binary systems that transform to ternary platinum-scandium-copper configurations through thermal diffusion processing.

Chart 100 shows the binary Pt5Ce alloy with well-defined peaks at approximately 33.5, 39.5 , 41.2, and 44.2 degrees corresponding to specific crystallographic planes of the hexagonal Pt5Ce intermetallic phase. The peak positions and intensities in chart 100 confirm formation of the ordered Pt5Ce structure with stoichiometric composition and high crystalline quality. In some embodiments, chart 100 reveals additional Pt5Ce reflections at higher angles including peaks at 70.1, 73.8, and 77.0 degrees corresponding to additional crystallographic planes that validate complete ordered phase formation throughout the binary alloy system. In some embodiments, the binary alloys in chart 100 comprise Pt3Ce compositions with peak positions shifted to different angular positions reflecting alternative stoichiometric ratios. In some embodiments, chart 100 shows binary Pt7Ce systems with modified peak intensity distributions corresponding to platinum-rich compositions. In some embodiments, the binary systems comprise platinum-lanthanum compositions including Pt5La and Pt3La stoichiometries with characteristic peak positions ranging from 32 to 45 degrees. In some embodiments, chart 100 demonstrates platinum-yttrium binary alloys including Pt5Y and Pt2Y compositions with peak patterns spanning 30 to 50 degrees.

In some embodiments, the binary Pt5Ce peaks in chart 100 demonstrate narrow peak widths indicating crystallite sizes ranging from 4 to 6 nanometers with minimal lattice strain and high structural ordering. In some embodiments, chart 100 shows peak intensity ratios that confirm preferred crystallographic orientations and compositional uniformity achieved through optimized solid-state synthesis conditions. In some embodiments, the binary alloy peaks exhibit crystallite sizes ranging from 3 to 8 nanometers depending on synthesis temperature and processing time. In some embodiments, chart 100 demonstrates binary systems with crystallite sizes extending from 2 to 10 nanometers for different rare earth metal compositions and synthesis conditions. In some embodiments, the synthesis conditions comprise temperature ranges from 650 to 850 degrees Celsius with processing times from 2 to 6 hours under hydrogen-containing atmospheres. In some embodiments, chart 100 shows systems synthesized using tube furnaces, rotary kilns, or fluidized bed reactors with controlled atmosphere compositions ranging from 5 to 20 percent hydrogen in inert gas mixtures.

The ternary Pt5Ce—Co pattern in chart 100 displays systematic peak position shifts toward higher diffraction angles and the emergence of shoulder peaks that provide direct evidence of successful cobalt incorporation and formation of multiple intermetallic phases. Chart 100 demonstrates that cobalt addition through thermal diffusion creates Pt3Co phases with cubic crystal structure while simultaneously preserving the original Pt5Ce hexagonal phases within the same nanoparticle system. The coexistence of both phase types creates the structural foundation for enhanced catalytic activity through synergistic electronic effects. In some embodiments, chart 100 shows peak shifts ranging from 0.2 to 0.4 degrees toward higher angles for the primary Pt5Ce reflections, indicating lattice parameter reduction from approximately 5.31 to 5.25 angstroms upon cobalt incorporation into the crystal structure. In some embodiments, the ternary system in chart 100 exhibits new reflections characteristic of Pt3Co phases at positions corresponding to cubic lattice parameters ranging from 3.85 to 3.88 angstroms. In some embodiments, chart 100 reveals peak broadening and shoulder formation that confirms the coexistence of both hexagonal Pt5Ce and cubic Pt3Co intermetallic phases within individual nanoparticles, creating compositional gradients essential for core-shell architecture formation.

In some embodiments, chart 100 demonstrates ternary platinum-cerium-nickel systems with Pt3Ni phase formation alongside preserved Pt5Ce phases. In some embodiments, the ternary systems comprise platinum-lanthanum-cobalt configurations showing Pt3Co and Pt5La phase coexistence. In some embodiments, chart 100 shows ternary platinum-yttrium-iron systems with multiple intermetallic phases including Pt3Fe and Pt5Y compositions. In some embodiments, the ternary alloys comprise platinum-scandium-cobalt systems with peak shifts indicating successful scandium and cobalt incorporation into multi-phase structures. In some embodiments, chart 100 demonstrates platinum-cerium-copper systems with Pt3Cu phase formation and associated peak emergence at characteristic cubic lattice positions. In some embodiments, the ternary systems are synthesized using chloride precursors including H2PtCl6, CeCl3, and CoCl2 with nitrogen-rich reducing agents. In some embodiments, chart 100 shows systems synthesized using nitrate precursors or acetate precursors with carbohydrazide, hydrazine, or ammonia borane as reducing agents.

The ternary alloy systems demonstrated in chart 100 achieve mass activities ranging from 1.5 to 3.0 amperes per milligram of platinum for oxygen reduction reactions, representing improvements of 200 to 400 percent compared to binary systems. In some embodiments, chart 100 corresponds to catalysts with electrochemical surface areas ranging from 40 to 80 square meters per gram of platinum. In some embodiments, the ternary systems demonstrate current densities from 1500 to 2000 milliamperes per square centimeter at 0.7 volts in fuel cell applications. In some embodiments, chart 100 represents catalysts suitable for polymer electrolyte membrane fuel cells, alkaline fuel cells, direct methanol fuel cells, and solid oxide fuel cells. In some embodiments, the ternary systems provide enhanced performance for electrolytic hydrogen production, metal-air batteries, and supercapacitor applications.

The structural analysis demonstrated in chart 100 represents fundamental crystallographic evidence validating the disclosed synthesis approach and confirming formation of ternary alloy systems with controlled multiple phase compositions. The peak evolution patterns in chart 100 establish that thermal diffusion processing successfully incorporates transition metals into binary platinum-rare earth systems while maintaining structural integrity and creating the phase diversity essential for enhanced catalytic performance in electrochemical applications including fuel cells, electrolyzers, and energy storage devices.

FIG. 1B illustrates particle 125 showing the binary platinum-cerium alloy structure achieved through solid-state synthesis, demonstrating the ordered atomic arrangement and compositional distribution within the Pt5Ce binary alloy system. Particle 125 shows the structural configuration prior to cobalt incorporation, providing the foundation for subsequent ternary alloy formation through thermal diffusion processes. The atomic-scale imaging reveals the spatial distribution of platinum and cerium components and confirms the formation of ordered Pt5Ce intermetallic phases essential for controlled ternary synthesis. This structural characterization validates the binary alloy formation methodology and establishes the precursor structure necessary for successful cobalt incorporation.

Particle 125 comprises a nanoparticle structure with approximately 5 nanometer diameter, exhibiting well-defined atomic arrangements that correspond to the ordered Pt5Ce intermetallic phases identified through X-ray diffraction analysis in chart 100. The particle morphology demonstrates controlled size distribution and structural uniformity achieved through optimized solid-state synthesis conditions. Particle 125 reveals the atomic-level organization within binary platinum-cerium systems, showing distinct elemental distributions that create the framework for subsequent ternary structure development. The imaging demonstrates that particle 125 maintains structural integrity and compositional control necessary for reproducible ternary alloy synthesis. In some embodiments, particle 125 exhibits diameters ranging from 3 to 8 nanometers depending on synthesis temperature and processing conditions. In some embodiments, particle 125 demonstrates hexagonal morphology consistent with the underlying crystal structure. In some embodiments, the synthesis utilizes precursor amounts ranging from 60 to 70 mg H2PtCl6·6H2O and 70 to 75 mg CeCl3·7H2O for controlled composition formation.

Platinum atoms 127 within particle 125 represent the primary metallic component distributed throughout the binary Pt5Ce alloy structure, forming the matrix that defines the overall nanoparticle architecture. The platinum atoms 127 create the fundamental framework for the ordered intermetallic structure and provide the electronic properties essential for catalytic activity. Platinum atoms 127 establish the crystallographic template that accommodates cerium incorporation while maintaining structural stability during synthesis processing. In some embodiments, platinum atoms 127 comprise 70 to 90 percent of the total metallic content within particle 125, corresponding to Pt5Ce stoichiometry. In some embodiments, platinum atoms 127 form ordered arrangements corresponding to hexagonal close-packed crystal structures characteristic of Pt5Ce intermetallic phases. In some embodiments, the platinum atoms 127 create atomic sites with specific coordination environments that optimize electronic interactions with cerium components. In some embodiments, the synthesis employs heating rates ranging from 8 to 12 degrees Celsius per minute during binary alloy formation.

Cerium atoms 129 within particle 125 are distributed throughout the platinum matrix, creating the Pt5Ce binary alloy composition essential for subsequent ternary structure formation. Cerium atoms 129 modify the electronic properties of the platinum matrix through their unique 4f orbital characteristics and establish the chemical environment necessary for controlled cobalt incorporation during thermal diffusion processing. The spatial distribution of cerium atoms 129 creates ordered Pt5Ce intermetallic phases that provide structural stability and electronic optimization. In some embodiments, cerium atoms 129 comprise 10 to 30 percent of the total metallic content within particle 125, forming stoichiometric Pt5Ce compositions. In some embodiments, cerium atoms 129 create alternative stoichiometries including Pt3Ce or Pt7Ce intermetallic structures. In some embodiments, the cerium atoms 129 provide electronic stabilization through lanthanide contraction effects that optimize platinum electronic properties. In some embodiments, rare earth metal atoms 129 comprise lanthanum atoms forming Pt5La or Pt3La binary compositions. In some embodiments, rare earth metal atoms 129 include yttrium atoms creating Pt5Y or Pt2Y intermetallic structures. In some embodiments, the binary alloy formation utilizes processing times ranging from 25 to 35 minutes at intermediate temperatures and 2.5 to 3.5 hours at final synthesis temperatures.

FIG. 1C illustrates particle 115 after cobalt incorporation through thermal diffusion, showing the ternary Pt5Ce—Co alloy structure with distinct spatial distribution of platinum, cerium, and cobalt components. The structural evolution from the binary particle 125 configuration shown in FIG. 1B to the ternary particle 115 in FIG. 1C demonstrates the effectiveness of thermal diffusion processing in creating controlled core-shell architectures with multiple intermetallic phases. Particle 115 maintains approximately the same nanoparticle size as particle 125 while achieving selective metal distribution that creates synergistic electronic effects between cerium and cobalt essential for enhanced catalytic performance. This atomic-scale characterization provides direct evidence of successful ternary alloy formation and validates the spatial distribution patterns predicted from the synthesis methodology.

Cobalt atoms 131 within particle 115 are distributed primarily in the outer regions of the nanoparticle, creating the core-shell architecture characteristic of the disclosed Pt5Ce—Co ternary alloy systems. The selective positioning of cobalt atoms 131 results from controlled thermal diffusion processing that incorporates cobalt into the existing Pt5Ce binary alloy structure with partial replacement of Cerium in the core region. Cobalt atoms 131 form Pt5Co-like intermetallic phases in the outer regions while preserving the a Pt3CeCo-like phases in the core areas. The cobalt incorporation creates multiple intermetallic phases within particle 115, enabling synergistic electronic effects that enhance catalytic activity beyond binary alloy capabilities. In some embodiments, cobalt atoms 131 comprise 5 to 25 percent of the total metallic content within particle 115. In some embodiments, cobalt atoms 131 form cubic L12 crystal structures characteristic of Pt3Co intermetallic phases. In some embodiments, the cobalt incorporation utilizes precursor amounts ranging from 5 to 6 mg anhydrous CoCl2 per 100 mg binary alloy. In some embodiments, transition metal atoms 131 comprise nickel atoms forming Pt3Ni intermetallic phases in the outer regions. In some embodiments, transition metal atoms 131 include iron atoms creating Pt3Fe structures distributed in peripheral areas. In some embodiments, the thermal diffusion processing employs times ranging from 1.5 to 2.5 hours at intermediate temperatures and 5 to 7 hours at final processing temperatures.

Platinum atoms 127 in particle 115 maintain their structural role as the primary matrix component while accommodating the newly incorporated cobalt atoms 131 through local structural adjustments. The platinum atoms 127 participate in forming multiple intermetallic phases simultaneously, creating both the preserved Pt5Ce phases in the core regions and the new Pt5Co phases in the outer regions of particle 115. This dual participation enables the optimal compressive effects that enhance catalytic performance beyond the capabilities of individual binary systems. In some embodiments, platinum atoms 127 in particle 115 exhibit modified electronic properties due to interactions with both cerium atoms 129 and cobalt atoms 131. In some embodiments, the platinum atoms 127 demonstrate enhanced d-band characteristics that optimize adsorption energies for electrochemical reaction intermediates. In some embodiments, the ternary systems achieve platinum loadings ranging from 10 to 15 micrograms per square centimeter for electrochemical testing. In some embodiments, platinum atoms 127 create bridging sites between rare earth and transition metal regions that facilitate electronic coupling effects. In some embodiments, platinum atoms 127 in particle 115 exhibit lattice compression ranging from 1.0 to 1.5 percent relative to pure platinum due to atomic size differences between the incorporated metals. In some embodiments, the lattice compression results from the smaller atomic radii of cobalt atoms 131 compared to platinum atoms 127, creating systematic contraction of the platinum crystal structure. In some embodiments, this lattice compression modifies the electronic properties of platinum atoms 127 and optimizes adsorption characteristics for oxygen reduction reaction intermediates. In some embodiments, the degree of lattice compression is determined by the ratio and spatial distribution of cobalt atoms 131 relative to platinum atoms 127 within particle 115.

Cerium atoms 129 in particle 115 remain concentrated primarily in the core regions, preserving the original Pt5Ce binary alloy composition while contributing to the overall electronic optimization of the ternary system. The preferential retention of cerium atoms 129 in the inner regions creates the compositional gradient essential for core-shell architecture formation. Cerium atoms 129 continue to provide electronic stabilization and contribute to the enhanced catalytic properties through long-range electronic effects that extend throughout particle 115. In some embodiments, cerium atoms 129 create electronic interactions that modify the catalytic properties of cobalt atoms 131 in the outer regions through electronic coupling effects. In some embodiments, the concentration gradient of cerium atoms 129 from core to surface ranges from 25 to 5 percent of the local metallic composition. In some embodiments, cerium atoms 129 maintain their 4f orbital characteristics that provide unique electronic contributions to the ternary alloy system. In some embodiments, the synthesis utilizes acid washing conditions with sulfuric acid concentrations ranging from 0.4 to 0.6 molar at temperatures from 65 to 75 degrees Celsius for 0.5 to 1.5 hours.

The ternary alloy catalyst systems demonstrated in particle 115 achieve mass activities ranging from 2.5 to 3.0 amperes per milligram of platinum for oxygen reduction reactions at beginning of life conditions, with retention of 1.4 to 1.7 amperes per milligram after 30,000 electrochemical cycles. In some embodiments, particle 115 demonstrates current densities from 1800 to 1900 milliamperes per square centimeter at 0.7 volts under heavy-duty vehicle testing conditions, maintaining 1400 to 1500 milliamperes per square centimeter after accelerated stress testing. In some embodiments, the ternary systems exhibit electrochemical surface area losses ranging from 10 to 20 percent after 30,000 cycles, demonstrating enhanced durability compared to conventional platinum catalysts. In some embodiments, the catalyst systems achieve fuel cell mass activities ranging from 700 to 750 milliamperes per milligram of platinum at 0.9 volts, retaining 250 to 300 milliamperes per milligram after durability testing. In some embodiments, particle 115 demonstrates ionomer to carbon ratios ranging from 0.4 to 0.6 for optimized electrochemical performance in membrane electrode assemblies.

The structural comparison between particle 125 in FIG. 1B and particle 115 in FIG. 1C provides direct evidence of controlled ternary alloy formation through thermal diffusion processing, demonstrating the selective metal distribution essential for enhanced catalytic performance in electrochemical applications including polymer electrolyte membrane fuel cells operating under heavy-duty vehicle conditions, alkaline electrolyzers, and energy storage systems requiring high activity and durability specifications.

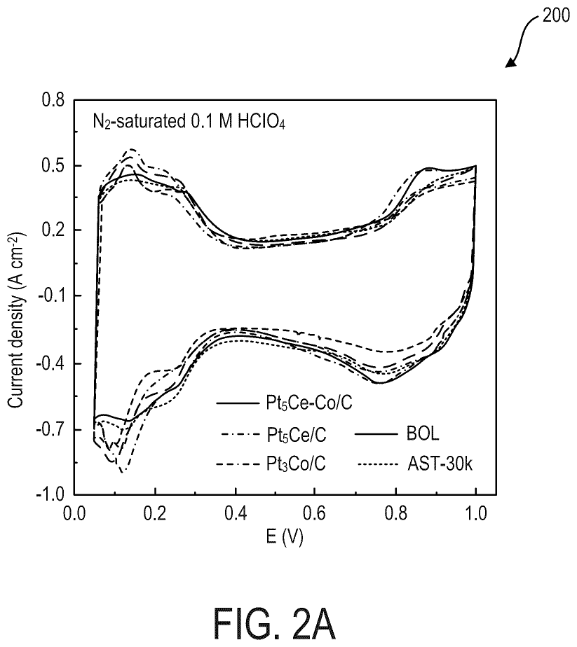

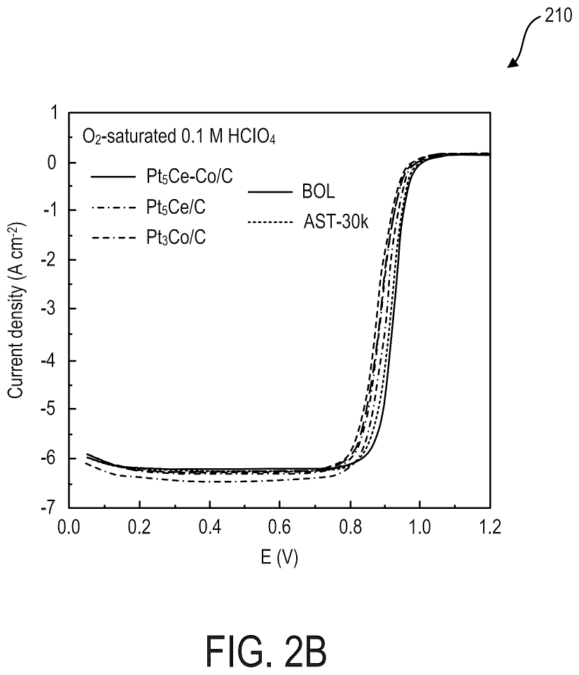

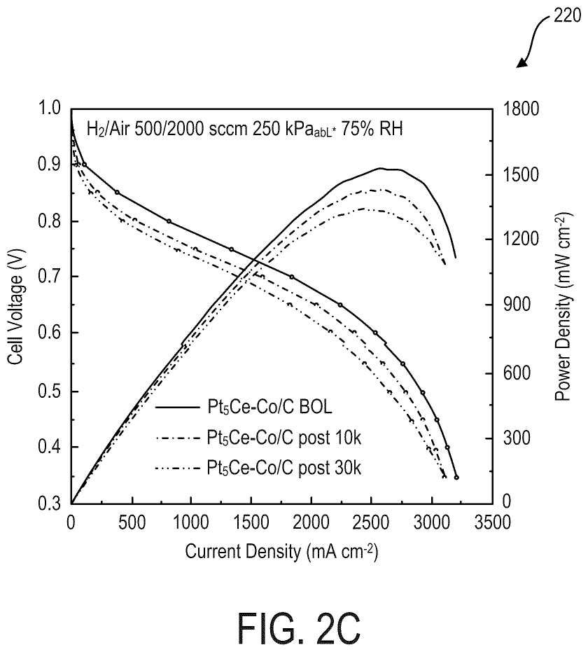

FIG. 2A illustrates chart 200 showing mass activity comparison for ternary and binary platinum-based alloy catalyst systems, demonstrating the superior electrochemical performance achieved through ternary alloy formation. Chart 200 shows mass activity comparison data revealing performance advantages of ternary systems over binary counterparts through controlled core-shell architectures and multiple intermetallic phases. The comparative performance data in chart 200 demonstrates quantitative relationships between alloy composition and catalytic activity for oxygen reduction reactions. The mass activity analysis enables identification of optimal alloy configurations and validates the enhanced performance achieved through synergistic electronic effects. This performance validation provides fundamental evidence that ternary alloy formation through thermal diffusion processing creates catalyst systems with superior activity essential for advanced electrochemical applications.

Chart 200 comprises mass activity data measured at 0.9 volts versus reversible hydrogen electrode in acid electrolyte, representing standardized conditions for catalyst performance evaluation. The comparative data in chart 200 spans three distinct catalyst systems including binary platinum-cerium alloys, binary platinum-cobalt alloys, and ternary platinum-cerium-cobalt systems. Chart 200 demonstrates systematic performance improvements achieved through controlled ternary alloy synthesis, with mass activity values increasing from binary to ternary configurations. The quantitative data reveals that ternary systems achieve mass activities exceeding both binary counterparts, validating the synergistic effects created through controlled metal distribution and multiple intermetallic phase formation.

Chart 200 shows the ternary Pt5Ce—Co catalyst system achieving mass activities ranging from 2.5 to 3.0 amperes per milligram of platinum, representing the highest performance among the compared systems. The superior activity of the ternary system results from synergistic electronic effects between cerium and cobalt components that optimize platinum electronic properties and create enhanced active site configurations. Chart 200 demonstrates that the ternary system maintains mass activities of 1.4 to 1.7 amperes per milligram after 30,000 electrochemical cycles, showing enhanced durability compared to binary systems. In some embodiments, chart 200 shows ternary platinum-cerium-cobalt systems with mass activities exceeding 2.8 amperes per milligram of platinum at beginning of life conditions. In some embodiments, the ternary systems in chart 200 demonstrate activity retention exceeding 50 percent after accelerated stress testing. In some embodiments, chart 200 reveals ternary platinum-lanthanum-nickel systems with mass activities ranging from 2.0 to 2.5 amperes per milligram of platinum.

The binary platinum-cobalt system in chart 200 exhibits mass activities ranging from 0.6 to 0.8 amperes per milligram of platinum, demonstrating intermediate performance between pure platinum and ternary systems. Chart 200 shows that binary Pt3Co catalysts provide enhanced activity compared to pure platinum through transition metal electronic effects but lack the additional optimization provided by rare earth metal incorporation. The binary platinum-cobalt performance establishes baseline activity levels that are subsequently enhanced through ternary alloy formation. In some embodiments, chart 200 demonstrates binary platinum-nickel systems with mass activities ranging from 0.5 to 0.7 amperes per milligram of platinum. In some embodiments, the binary systems show activity degradation ranging from 20 to 40 percent after 30,000 cycles. In some embodiments, chart 200 reveals binary platinum-iron systems with mass activities from 0.4 to 0.6 amperes per milligram of platinum.

The binary platinum-cerium system in chart 200 displays mass activities ranging from 0.3 to 0.5 amperes per milligram of platinum, representing the lowest activity among the compared systems while demonstrating enhanced stability characteristics. Chart 200 shows that binary Pt5Ce catalysts provide electronic stabilization through rare earth metal effects but require transition metal incorporation to achieve optimal activity levels. The binary platinum-cerium performance demonstrates the importance of transition metal addition for achieving enhanced catalytic activity while maintaining the stability benefits of rare earth metal incorporation. In some embodiments, chart 200 shows binary platinum-lanthanum systems with mass activities ranging from 0.25 to 0.45 amperes per milligram of platinum. In some embodiments, the binary rare earth systems demonstrate exceptional stability with activity retention exceeding 80 percent after extended cycling. In some embodiments, chart 200 reveals binary platinum-yttrium systems with mass activities from 0.2 to 0.4 amperes per milligram of platinum.

FIG. 2B illustrates chart 210 showing oxygen reduction reaction polarization curves comparing ternary and binary platinum-based catalyst systems under rotating disk electrode conditions, demonstrating current-potential relationships that define catalytic performance characteristics. Chart 210 shows polarization curves revealing electrochemical behavior differences between binary and ternary systems through current density responses across potential ranges. The comparative polarization data in chart 210 demonstrates kinetic and mass transport characteristics that determine overall catalyst performance for oxygen reduction reactions. The current-potential analysis enables identification of onset potentials, kinetic regions, and mass transport limitations that define catalyst effectiveness. This electrochemical characterization provides direct evidence that ternary alloy formation creates improved reaction kinetics essential for enhanced fuel cell performance.

Chart 210 comprises current density data plotted against electrode potential from approximately 1.0 to 0.4 volts versus reversible hydrogen electrode, encompassing the operating range for fuel cell cathode applications. The polarization curves in chart 210 reveal distinct kinetic behaviors for different catalyst compositions, with ternary systems demonstrating enhanced current densities across the entire potential range. Chart 210 shows systematic improvements in both kinetic and mass transport regions achieved through ternary alloy formation, indicating enhanced catalytic activity and improved reaction mechanisms. The electrochemical data demonstrates that ternary systems achieve higher current densities at equivalent potentials compared to binary counterparts, validating the enhanced catalytic properties created through controlled core-shell architectures.

The ternary Pt5Ce—Co polarization curve in chart 210 exhibits the highest current densities across all potential regions, achieving current densities exceeding 5 amperes per square centimeter at 0.6 volts versus reversible hydrogen electrode. Chart 210 demonstrates that the ternary system maintains superior performance throughout the kinetic region from 0.9 to 0.7 volts, indicating enhanced reaction kinetics compared to binary systems. The ternary catalyst shows improved mass transport characteristics in the lower potential region, suggesting optimized catalyst layer properties and enhanced oxygen accessibility. In some embodiments, chart 210 shows ternary systems achieving current densities exceeding 6 amperes per square centimeter at 0.5 volts. In some embodiments, the ternary polarization curves demonstrate onset potentials within 50 to 100 millivolts of reversible hydrogen electrode potential. In some embodiments, chart 210 reveals ternary platinum-lanthanum-nickel systems with current densities ranging from 4 to 5 amperes per square centimeter at 0.6 volts.

The binary platinum-cobalt polarization curve in chart 210 demonstrates intermediate performance with current densities ranging from 3 to 4 amperes per square centimeter at 0.6 volts, showing enhanced activity compared to platinum-rare earth systems but lower performance than ternary configurations. Chart 210 shows that binary Pt3Co catalysts exhibit good kinetic performance in the high potential region but demonstrate limitations in the mass transport region compared to ternary systems. The binary transition metal system provides baseline electrochemical characteristics that are subsequently enhanced through rare earth metal incorporation in ternary configurations. In some embodiments, chart 210 demonstrates binary platinum-nickel systems with current densities from 2.5 to 3.5 amperes per square centimeter at 0.6 volts. In some embodiments, the binary transition metal systems show kinetic current densities ranging from 2 to 3 amperes per square centimeter at 0.9 volts. In some embodiments, chart 210 reveals binary platinum-iron systems with current densities from 2 to 3 amperes per square centimeter at 0.6 volts.

The binary platinum-cerium polarization curve in chart 210 exhibits the lowest current densities among the compared systems, achieving current densities ranging from 1.5 to 2.5 amperes per square centimeter at 0.6 volts while demonstrating stable electrochemical behavior. Chart 210 shows that binary Pt5Ce catalysts provide consistent performance across the potential range but require transition metal enhancement to achieve optimal current densities. The binary rare earth system establishes the stability foundation that is subsequently optimized through transition metal incorporation in ternary configurations. In some embodiments, chart 210 shows binary platinum-lanthanum systems with current densities from 1 to 2 amperes per square centimeter at 0.6 volts. In some embodiments, the binary rare earth systems demonstrate exceptional potential stability with minimal performance degradation across extended potential ranges. In some embodiments, chart 210 reveals binary platinum-yttrium systems with current densities from 0.8 to 1.8 amperes per square centimeter at 0.6 volts.

FIG. 2C illustrates chart 220 showing fuel cell polarization and power density curves for ternary platinum-cerium-cobalt catalyst systems under membrane electrode assembly testing conditions, demonstrating practical device performance characteristics. Chart 220 shows fuel cell performance data revealing current-voltage relationships and power output characteristics that define real-world application capabilities. The fuel cell testing data in chart 220 demonstrates system-level performance achieved through ternary catalyst integration in membrane electrode assemblies under heavy-duty vehicle operating conditions. The polarization and power density analysis enables evaluation of catalyst effectiveness in practical fuel cell systems and validates performance improvements under realistic operating environments. This device-level characterization provides fundamental evidence that ternary alloy catalysts create enhanced fuel cell performance essential for commercial electrochemical applications.

Chart 220 comprises current density and power density data measured under fuel cell operating conditions including hydrogen and air reactants at elevated temperature and pressure representative of automotive applications. The performance curves in chart 220 span current densities from 0 to 3000 milliamperes per square centimeter with corresponding voltage and power density measurements. Chart 220 demonstrates fuel cell performance characteristics achieved through ternary catalyst implementation, showing both polarization losses and power generation capabilities across the operating range. The fuel cell data reveals system-level benefits of ternary catalyst technology and validates the enhanced performance predicted from fundamental electrochemical characterization.

The polarization curve in chart 220 shows fuel cell voltage performance ranging from open circuit voltage to maximum current density conditions, demonstrating voltage-current relationships that define fuel cell operating characteristics. Chart 220 demonstrates that ternary Pt5Ce—Co catalysts enable fuel cell operation at current densities exceeding 1800 to 1900 milliamperes per square centimeter at 0.7 volts under beginning of life conditions. The ternary catalyst system maintains current densities of 1400 to 1500 milliamperes per square centimeter at 0.7 volts after 30,000 accelerated stress test cycles, demonstrating enhanced durability under realistic operating conditions. In some embodiments, chart 220 shows fuel cell systems achieving current densities exceeding 2000 milliamperes per square centimeter at 0.6 volts with ternary catalysts. In some embodiments, the fuel cell performance demonstrates open circuit voltages ranging from 0.95 to 1.0 volts under hydrogen-air operation. In some embodiments, chart 220 reveals ternary catalyst systems enabling fuel cell operation with platinum loadings ranging from 0.15 to 0.25 milligrams per square centimeter.

The power density curve in chart 220 exhibits maximum power output ranging from 1200 to 1400 milliwatts per square centimeter, representing enhanced power generation capabilities achieved through ternary catalyst optimization. Chart 220 demonstrates that peak power occurs at intermediate current densities where voltage and current product optimization balances polarization losses with power generation requirements. The power density characteristics validate the practical benefits of ternary catalyst technology for high-performance fuel cell applications requiring enhanced power output and efficiency. In some embodiments, chart 220 shows power densities exceeding 1500 milliwatts per square centimeter under optimized operating conditions. In some embodiments, the power density curves demonstrate sustained power output exceeding 1000 milliwatts per square centimeter across broad current density ranges. In some embodiments, chart 220 reveals ternary catalyst systems achieving power densities from 800 to 1200 milliwatts per square centimeter under heavy-duty vehicle testing protocols.

The fuel cell performance demonstrated in chart 220 achieves mass activities ranging from 700 to 750 milliamperes per milligram of platinum at 0.9 volts under membrane electrode assembly conditions, with retention of 250 to 300 milliamperes per milligram after durability testing. In some embodiments, chart 220 demonstrates fuel cell systems with ionomer to carbon ratios ranging from 0.4 to 0.6 for optimized catalyst layer performance. In some embodiments, the fuel cell testing employs gas flow rates ranging from 400 to 600 standard cubic centimeters per minute for hydrogen and 1800 to 2200 standard cubic centimeters per minute for air. In some embodiments, chart 220 shows fuel cell operation at cell temperatures from 75 to 85 degrees Celsius with relative humidity ranging from 70 to 80 percent. In some embodiments, the fuel cell systems demonstrate enhanced performance for polymer electrolyte membrane fuel cells, direct methanol fuel cells, and high-temperature polymer electrolyte membrane applications.

The performance comparison across charts 200, 210, and 220 provides comprehensive validation of ternary alloy catalyst technology, demonstrating enhanced mass activity, improved electrochemical kinetics, and superior fuel cell performance essential for advanced electrochemical applications including automotive fuel cells, stationary power systems, and portable energy devices requiring high activity, durability, and power density specifications.

### Example Flowchart(s)

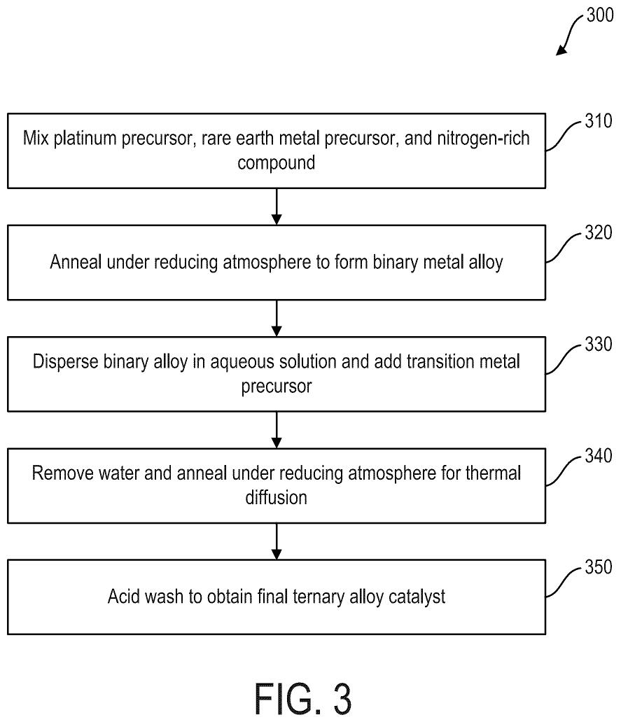

Embodiments of the present disclosure provide various methods for synthesizing ternary metal alloy catalysts through sequential solid-state synthesis and thermal diffusion processes, such as described herein. Various examples of the operations performed in accordance with some embodiments of the present disclosure will now be provided with reference to FIG. 3.

FIG. 3 illustrates flowchart 300 of an example method for synthesizing ternary metal alloy catalysts through systematic transformation of binary alloy precursors into controlled core-shell structures with multiple intermetallic phases. Flowchart 300 shows the sequential synthesis process demonstrating systematic transformation of precursor materials into ternary alloy systems with enhanced catalytic properties. The process workflow in flowchart 300 demonstrates controlled formation of binary alloy foundations followed by transition metal incorporation through thermal diffusion processes. The systematic approach enables identification of optimal synthesis parameters and confirms formation of core-shell architectures essential for enhanced electrochemical performance. This process methodology provides fundamental guidance that thermal diffusion processing successfully creates ternary alloy catalysts with controlled compositions and structures essential for superior catalytic activity in electrochemical applications.

The method workflow begins at operation 310 with mixing platinum precursors, rare earth metal precursors, and nitrogen-rich compounds to create homogeneous solid-state mixtures for controlled binary alloy formation. Operation 310 comprises combining precursor materials in stoichiometric ratios that define the final binary alloy composition while ensuring uniform distribution of reactive components. The mixing process in operation 310 utilizes mechanical grinding and blending techniques that create intimate contact between precursor materials and nitrogen-rich reducing agents. Operation 310 establishes the compositional foundation for subsequent binary alloy synthesis and determines the structural characteristics of the final ternary catalyst system.

At operation 310, mortar and pestle grinding techniques combine platinum precursors, rare earth metal precursors, and nitrogen-rich compounds into homogeneous mixtures. Operation 310 implements mixing procedures that achieve uniform distribution of H2PtCl6·6H2O, CeCl3·7H2O, and carbohydrazide components throughout the precursor mixture. The mixing process creates intimate contact between reactive species and establishes optimal conditions for subsequent solid-state synthesis reactions. In some embodiments, operation 310 utilizes precursor amounts ranging from 60 to 70 mg H2PtCl6·6H2O combined with 70 to 75 mg CeCl3·7H2O and 500 to 540 mg carbohydrazide. In some embodiments, the mixing process in operation 310 employs ball milling or high-energy grinding techniques for enhanced homogenization. In some embodiments, operation 310 incorporates carbon support materials including 90 to 110 mg KB carbon during the mixing process to create supported catalyst precursors.

Operation 320 comprises annealing the mixed precursors at elevated temperatures under reducing atmospheres to form binary platinum-rare earth alloy systems with ordered intermetallic structures. The annealing process in operation 320 utilizes controlled temperature programs that enable solid-state reactions while preventing material decomposition or unwanted phase formation. Operation 320 implements reducing atmosphere conditions that facilitate metal reduction and alloy formation while protecting reactive materials from oxidation. The thermal processing creates ordered binary alloy phases that provide the structural foundation for subsequent ternary catalyst development through transition metal incorporation.

At operation 320, tube furnace systems provide controlled heating under hydrogen-containing atmospheres with precise temperature and atmosphere regulation. Operation 320 implements heating programs that raise temperature from ambient to 750 to 800 degrees Celsius at rates of 8 to 12 degrees per minute with intermediate holds at 170 to 190 degrees Celsius for 25 to 35 minutes. The annealing process maintains final temperatures for 2.5 to 3.5 hours under hydrogen concentrations ranging from 5 to 10 percent in inert gas mixtures. In some embodiments, operation 320 includes an intermediate temperature hold at 170 to 190 degrees Celsius for 25 to 35 minutes before reaching final annealing temperatures. In some embodiments, operation 320 utilizes rotary kiln systems or fluidized bed reactors for larger scale binary alloy synthesis. In some embodiments, the annealing process employs alternative reducing atmospheres including ammonia or carbon monoxide for specialized synthesis conditions. In some embodiments, operation 320 implements rapid thermal annealing techniques with heating rates exceeding 50 degrees per minute for enhanced process efficiency.

Operation 330 comprises dispersing the binary alloy in aqueous solutions and adding transition metal precursors to enable controlled incorporation through subsequent thermal diffusion processing. The dispersion process in operation 330 creates uniform suspensions of binary alloy nanoparticles that facilitate homogeneous transition metal distribution during thermal diffusion. Operation 330 implements transition metal precursor addition procedures that achieve controlled concentrations and uniform mixing throughout the binary alloy suspension. The aqueous processing prepares the binary alloy system for transition metal incorporation while maintaining structural integrity and compositional control.

At operation 330, sonication techniques disperse binary alloy particles in deionized water at concentrations of 4 to 6 mg per mL with processing times of 10 to 20 minutes. Operation 330 implements transition metal precursor addition through controlled dissolution of CoCl2 in separate aqueous solutions followed by gradual addition to the binary alloy suspension. The mixing process employs continued sonication for 1.5 to 2.5 hours to ensure uniform distribution of transition metal precursors throughout the suspension. In some embodiments, operation 330 utilizes transition metal precursor amounts ranging from 5 to 6 mg anhydrous CoCl2 per 100 mg binary alloy. In some embodiments, the dispersion process employs alternative solvents including ethanol or isopropanol for specialized processing conditions. In some embodiments, operation 330 implements ultrasonic bath systems or probe sonicators for enhanced dispersion uniformity.

Operation 340 comprises removing water from the suspension and annealing under reducing atmospheres to achieve thermal diffusion of transition metals into the binary alloy structure. The water removal process in operation 340 utilizes controlled evaporation techniques that preserve uniform transition metal distribution while creating dry powders suitable for thermal processing. Operation 340 implements thermal diffusion annealing that incorporates transition metals into binary alloy systems through controlled high-temperature processing under reducing atmospheres. The thermal diffusion creates ternary alloy structures with core-shell architectures and multiple intermetallic phases essential for enhanced catalytic performance.

At operation 340, rotary evaporation systems remove water at temperatures of 55 to 65 degrees Celsius under reduced pressure conditions. Operation 340 implements thermal diffusion annealing with heating programs that raise temperature to 640 to 660 degrees Celsius at rates of 6 to 10 degrees per minute with intermediate holds at 390 to 410 degrees Celsius for 1.5 to 2.5 hours. The final annealing maintains temperatures for 5 to 7 hours under hydrogen concentrations of 5 to 10 percent in inert gas atmospheres. In some embodiments, operation 340 utilizes microwave-assisted drying techniques for accelerated water removal. In some embodiments, the thermal diffusion process employs plasma-enhanced annealing for specialized structural modifications. In some embodiments, operation 340 implements gradient heating profiles with multiple temperature plateaus for controlled phase formation.

Operation 350 comprises acid washing the ternary alloy products to remove impurities and obtain final catalyst materials with optimized surface properties and compositional purity. The acid washing process in operation 350 utilizes controlled chemical treatment that removes unreacted precursors and oxide impurities while preserving ternary alloy structures. Operation 350 implements washing procedures that optimize surface composition and electrochemical properties for enhanced catalytic performance. The purification process creates final ternary catalyst products suitable for electrochemical applications with controlled composition and surface characteristics.

At operation 350, sulfuric acid solutions with concentrations ranging from 0.4 to 0.6 molar at temperatures of 65 to 75 degrees Celsius for 0.5 to 1.5 hours provide controlled purification. Operation 350 implements multiple washing cycles with deionized water to achieve neutral pH and remove residual acid from the catalyst products. The washing process employs filtration and centrifugation techniques that separate purified catalysts from wash solutions while maintaining structural integrity. In some embodiments, operation 350 utilizes alternative acid solutions including hydrochloric acid or nitric acid for specialized purification requirements. In some embodiments, the washing process employs ultrasonic agitation for enhanced impurity removal. In some embodiments, operation 350 implements electrochemical cleaning techniques for advanced surface optimization.

The systematic workflow illustrated in flowchart 300 enables controlled synthesis of ternary metal alloy catalysts through sequential solid-state synthesis and thermal diffusion processes that create core-shell architectures with multiple intermetallic phases. The process methodology addresses the computational and practical challenges associated with rare earth metal incorporation while achieving enhanced catalytic performance exceeding binary alloy capabilities. The controlled synthesis approach enables formation of ternary alloy systems with mass activities ranging from 2.5 to 3.0 amperes per milligram of platinum and enhanced durability characteristics essential for advanced electrochemical applications including fuel cells, electrolyzers, and energy storage devices.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that any particular order be inferred.

### Conclusion

Many modifications and other embodiments of the disclosures set forth herein will come to mind to one skilled in the art to which these present disclosures pertain having the benefit of the teachings presented in the foregoing descriptions and the associated drawings. Therefore, it is to be understood that the embodiments of the present disclosure are not to be limited to the specific embodiments disclosed and that modifications and other embodiments are intended to be included within the scope of the present disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the present disclosure. In this regard, for example, different combinations of elements and/or functions than those explicitly described above are also contemplated within the scope of the present disclosure. Although specific terms are employed herein, they are used in a generic and descriptive sense only and not for purposes of limitation.

I/We claim:

1. A method for synthesizing a ternary metal alloy, the method comprising:
forming a binary metal alloy through solid-state synthesis;
incorporating a third metal into the binary metal alloy through thermal diffusion; and
annealing under a reducing atmosphere to form ternary alloy nanoparticles;
wherein the ternary alloy nanoparticles comprise a core-shell structure with a first metal of the binary alloy concentrated in an inner region and the third metal distributed in outer regions; and wherein the ternary alloy nanoparticles comprise multiple intermetallic phases.

2. The method of claim 1, wherein the binary metal alloy comprises platinum and a rare earth metal.

3. The method of claim 2, wherein the rare earth metal is cerium.

4. The method of claim 2, wherein the binary metal alloy comprises Pt5Ce.

5. The method of claim 1, wherein the third metal is a transition metal.

6. The method of claim 5, wherein the transition metal is cobalt.

7. The method of claim 1, wherein the multiple intermetallic phases comprise a first phase having an ordered intermetallic structure and a second phase having an ordered intermetallic structure.

8. The method of claim 1, wherein the multiple intermetallic phases comprise Pt5Ce and Pt3Co.

9. The method of claim 8, wherein the Pt5Ce is concentrated in the inner region and the Pt3Co is distributed in the outer regions.

10. The method of claim 1, wherein the solid-state synthesis comprises mixing a platinum precursor, a cerium precursor, and a nitrogen-rich compound.

11. The method of claim 10, wherein the nitrogen-rich compound is carbohydrazide.

12. The method of claim 1, wherein forming the binary metal alloy comprises annealing at a temperature between 700° C. and 800° C.

13. The method of claim 1, wherein the thermal diffusion comprises annealing at a temperature between 600° C. and 700° C.

14. The method of claim 1, wherein the reducing atmosphere comprises hydrogen or a hydrogen-containing gas mixture.

15. The method of claim 1, wherein the ternary alloy nanoparticles further comprise a platinum-enriched shell surrounding the outer regions.

16. The method of claim 1, wherein the ternary alloy nanoparticles are supported on a carbon support material.

17. A method for synthesizing a ternary platinum-rare earth-transition metal alloy catalyst for fuel cell applications, the method comprising:
forming a binary platinum-rare earth metal alloy through solid-state synthesis comprising mixing a platinum precursor, a rare earth metal precursor, and a nitrogen-rich compound;
incorporating a transition metal into the binary platinum-rare earth metal alloy through thermal diffusion comprising dispersing the binary alloy in an aqueous solution and adding a transition metal precursor; and
annealing under a hydrogen-containing atmosphere at a temperature between 600° C. and 700° C. to form ternary alloy nanoparticles; wherein the ternary alloy nanoparticles comprise a core-shell structure with the rare earth metal concentrated in an inner region and the transition metal distributed in outer regions.

18. The method of claim 17, wherein the rare earth metal is cerium and the transition metal is cobalt.

19. The method of claim 17, wherein the ternary alloy nanoparticles comprise Pt5Ce and Pt3Co phases.

20. The method of claim 17, wherein the ternary alloy nanoparticles are deposited on a carbon support material.
